(19) United States
(12) Patent Application Publication
(10) Pub. No.: US 2024/0162650 A1
(43) Pub. Date: May 16, 2024

(54) CONNECTOR WITH A COUPLING ELEMENT HAVING TWO PROTUBERANCES

(71) Applicant: Aptiv Technologies AG, Schaffhausen (CH)

(72) Inventors: Uvaraj GANESAN, Chennai (IN); Annabelle Gueux, Senantes (FR); Laurent Delescluse, Saint Piat (FR)

(21) Appl. No.: 18/508,522

(22) Filed: Nov. 14, 2023

(30) Foreign Application Priority Data
Nov. 14, 2022 (FR) 2211807

(51) Int. Cl. H01R 13/627

(52) U.S. Cl. CPC H01R 13/6271

(57) ABSTRACT

An electrical connector which is designed to be connected and coupled in a direction of introduction to a corresponding electrical connector, the electrical connector having a coupling element extending in the direction of introduction. The coupling element has a first protuberance extending in a first direction perpendicular to the direction of introduction and at least one second protuberance extending in a second direction which is perpendicular to the first direction and to the direction of introduction.

### CROSS-REFERENCE TO RELATED APPLICATION

This application claims the benefit of and priority to French Patent Application No. 2211807, titled “Connecteur avec un Élément de Couplage Ayant Deux Protuberances Domaine Technique de L'invention” filed Nov. 14, 2022, the contents of which are incorporated by reference herein.

### TECHNICAL FIELD OF THE INVENTION

The present description concerns an electrical connector in general, which is designed to be connected to a corresponding electrical connector (for example a male connector and a female connector), and in particular configured for automotive applications.

### BACKGROUND

In many applications, it is necessary to fit electric cables and to connect them to one another. In particular, it is advantageous to make the connection as reliable as possible as far as vibration resistance is concerned.

Electrical connectors are already known which comprise blocking elements in order to limit the movement of the male and female connectors which are joined. Reference is made in particular to document US Patent Application Publication No. 2003/0054681.

However, the electrical connectors can be damaged in the case of vibrations or mechanical forces on the connectors, which tend to make them move relative to one another or to detach them, which can be the case for example in a motor vehicle or a mobile machine. The general running of the vehicle or machine can be adversely affected if the connection is lost or interrupted.

Because of these disadvantages, it is desirable to have an electrical connector which is resistant to vibrations and forces, in particular to exterior forces which tend to disconnect the connector.

### SUMMARY

An objective of the present disclosure is to respond to the disadvantages of the aforementioned prior art and to improve the resistance to vibrations of the electrical connectors and to forces, in particular to the exterior forces which tend to disconnect the connectors, and thus firstly to propose an electrical connector which is designed to be connected and coupled in a direction of introduction to a corresponding electrical connector, and electrical connector having a coupling element which extends at least in the direction of introduction. The coupling element has at least one first protuberance in a first direction perpendicular to the direction of introduction and at least one second protuberance in a second direction, perpendicular to the first direction and to the direction of introduction.

This makes it possible to provide a connector with improved resistance to vibrations, which has better securing, is simpler to produce, more simple, more compact, and uses fewer parts. Thus, the vibrations in the first direction and in the second direction are limited, as are the vibrations in the direction of introduction. Thus, the coupling element can penetrate into a receptacle or housing (for example a slot or a hole) of the corresponding electrical connector. In particular, the receptacle can cooperate with the coupling element as an introduction guide, in particular when it is substantially flat.

The coupling element can be inserted in the receptacle, and penetrate into it or be inserted therein, in particular in the direction of introduction (or direction of insertion). The coupling element permits mechanical coupling and/or pairing of the electrical connector and the corresponding electrical connector. In other words, the present disclosure is intended for a male terminal support in a set of connectors, the male terminal support having flexible protuberances in order to control the vibrations in various directions when the male connector is coupled to the female connector.

Advantageously, the electrical connector is a male connector which is designed to be connected and coupled to the corresponding electrical connector, which is a female connector. This makes it possible to connect the electrical connector to another corresponding electrical connector, i.e., which is compatible.

Advantageously, the coupling element has at least one flexible portion, the at least one flexible portion having the first protuberance and the second protuberance. This makes it possible to propose a flexible (or resiliently deformable) portion, such as to improve the resistance to vibrations, and therefore make the connection more reliable.

Advantageously, the coupling element comprises a central portion and two flexible portions, each having the first protuberance and the second protuberance. This makes it possible to improve the resistance to vibrations, and therefore make the connection more reliable. Thus, the vibrations in the first direction and in the second direction are limited. The same applies in the direction of introduction.

Advantageously, the central portion is separated from the flexible portions by two openings or slots. This makes it possible to simplify the structure of the connector, and to propose flexible portions which improve the resistance to vibrations.

Advantageously, the central portion has a third protuberance.

Advantageously, the central portion is also flexible. This makes it possible to improve the resistance to vibrations of the connector.

Advantageously, the coupling element is substantially flat, preferably in the first direction and the direction of introduction. This makes it possible to improve the guiding of the connector.

Advantageously, the first protuberance and/or the second protuberance project(s) or extend(s) towards the exterior of the coupling element.

Advantageously, the coupling element projects or extends in the direction of introduction.

Advantageously, the coupling element is an introduction guide. This makes it possible to guide the electrical connector during the connection with the corresponding electrical connector.

In particular, the coupling element (or the introduction guide, which is also known as the guiding projection) can extend a face of a base in the direction of introduction and penetrate into the corresponding receptacle (or guiding slot or pocket). The coupling element and the corresponding receptacle guide the movements of the electrical connectors at the moment of connection and prevent the deformation of the electric plugs or pins and/or damage to the contacts, which increases the tolerance to incorrect handling during the connection.

Substantially flat coupling elements, which have the form of a sheet or a plate, associated with slots on the corresponding electrical connector (guiding slots or pockets) in the form of a casing or sheath to receive them, are extremely efficient in guiding the movements of the electrical connectors, since at least two guiding surfaces of the introduction guide (or of the corresponding slots) are far wider than the other guiding surfaces.

Advantageously, the first protuberance and the second protuberance are designed to interfere with a base of the corresponding electrical connector. This makes it possible to improve further the resistance to vibrations and to make the connection reliable.

Advantageously, the electrical connector has at least one electric plug. This makes it possible to assure the electrical connection, i.e., to permit the passage of electric current or an electrical signal.

According to a second aspect, the disclosure concerns a connector assembly having an electrical connector according to the first aspect, and a corresponding electrical connector designed to be connected thereto. This makes it possible to propose an electrical connector (in particular a male connector) which can be connected to a corresponding electrical connector (in particular a female connector) such as to form a connector assembly.

### BRIEF DESCRIPTION OF THE DRAWINGS

The present invention is now described, by way of example with reference to the accompanying drawings, in which:

FIG. 1 represents a view in perspective of an electrical connector according to a first embodiment, connected to a corresponding electrical connector, such as to form a connector assembly according to some embodiments.

FIG. 2 represents a view in perspective of the corresponding electrical connector (female) according to some embodiments.

FIG. 3 represents a view in perspective of the electrical connector (male) according to some embodiments.

FIG. 4 represents a first view in cross-section of the electrical connector connected to the corresponding electrical connector according to some embodiments.

FIG. 5 represents a second view in cross-section of the electrical connector connected to the corresponding electrical connector according to some embodiments.

FIG. 6 represents a detailed view of the electrical connector according to the first embodiment, seen from a first side according to some embodiments.

FIG. 7 represents a detailed view of the electrical connector according to the first embodiment, seen from a second side, opposite the first side according to some embodiments.

FIG. 8 represents a represents a third view in cross-section of the electrical connector connected to the corresponding electrical connector according to some embodiments.

FIG. 9 represents a fourth view in cross-section of the electrical connector connected to the corresponding electrical connector according to some embodiments.

FIG. 10 represents a view in perspective of the corresponding electrical connector, with views in cross-section showing a secondary lock according to some embodiments.

FIG. 11 represents a view in cross-section of the corresponding electrical connector according to some embodiments.

FIG. 12 represents a view in cross-section of the electrical connector according to some embodiments.

FIG. 13 represents a view in cross-section of the electrical connector and the corresponding electrical connector connected together according to some embodiments.

### DETAILED DESCRIPTION

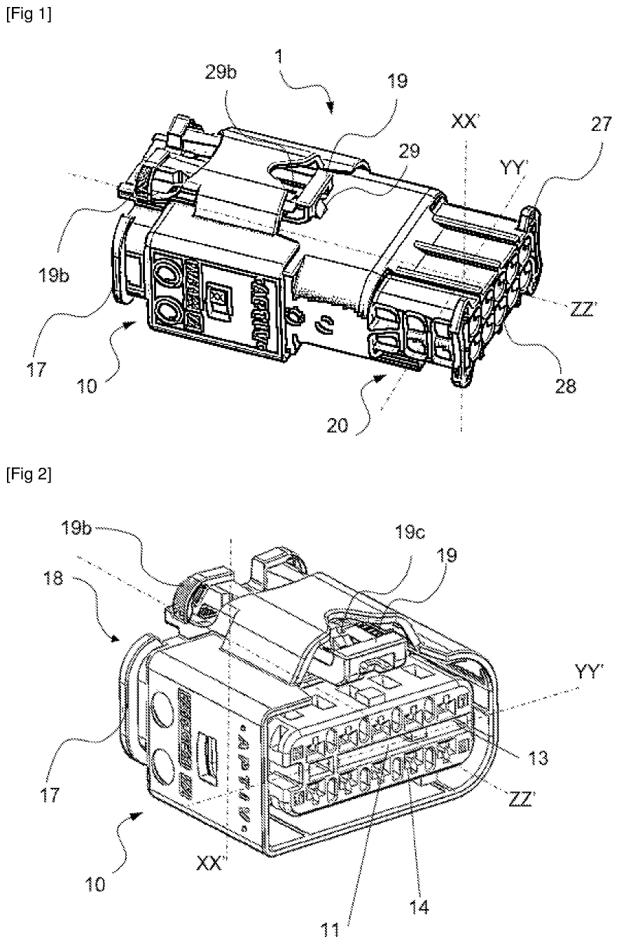

FIG. 1 represents a view in perspective of an electrical connector 20 according to a first embodiment connected to a corresponding electrical connector 10, such as to form a connector assembly 1. The electrical connector 20 is represented inserted in the corresponding electrical connector 10, in a first direction of introduction ZZ′ (or direction of insertion ZZ′). Thus, the electrical connector 20 and the corresponding electrical connector 10 are connected or paired.

The electrical connector 20 comprises protrusions 29, 29b which are designed to be coupled to a hook 19 (having a base 19b) of the corresponding electrical connector 10. The protrusions 29, 29b and the hook 19 (with the base 19b) form a securing system and can be replaced by any other equivalent securing system, in order to secure the electrical connector 20 and the corresponding electrical connector 10 together. Reference is made for example to a securing system with a lever and a notch.

The electrical connector 20 has a grasping portion 27 in order to facilitate gripping thereof by the user and facilitate the insertion. Similarly, the corresponding electrical connector 10 has a grasping portion 17.

FIG. 2 represents a view in perspective of the corresponding electrical connector 10.

The reference numbers are repeated as many times as is necessary in the figures.

The corresponding electrical connector 10 has a stop portion 19c in order to abut the protrusion 29b of the electrical connector 20.

The corresponding electrical connector 10 has a receptacle 11 (or housing 11), preferably with a form which extends in a first direction YY′ perpendicular to the direction of introduction ZZ′. The receptacle 11 is designed to receive a coupling element 21 of the electrical connector 20, as will be described hereinafter.

The corresponding electrical connector 10 also has another receptacle 13 arranged in the vicinity of the receptacle 11, in the first direction YY′. The other receptacle 13 is designed to receive another coupling element 23, as will be described hereinafter. It should be noted that the other receptacle 13 and the other coupling element 23 are optional.

The corresponding electrical connector 10 also has a plurality of female (electrical) terminals 14, which are designed to receive male (electrical) terminals 24 of the electrical connector 20, as will be described hereinafter. The corresponding electrical connector 10 is thus preferably a female connector, and the electrical connector 20 is thus preferably a male connector.

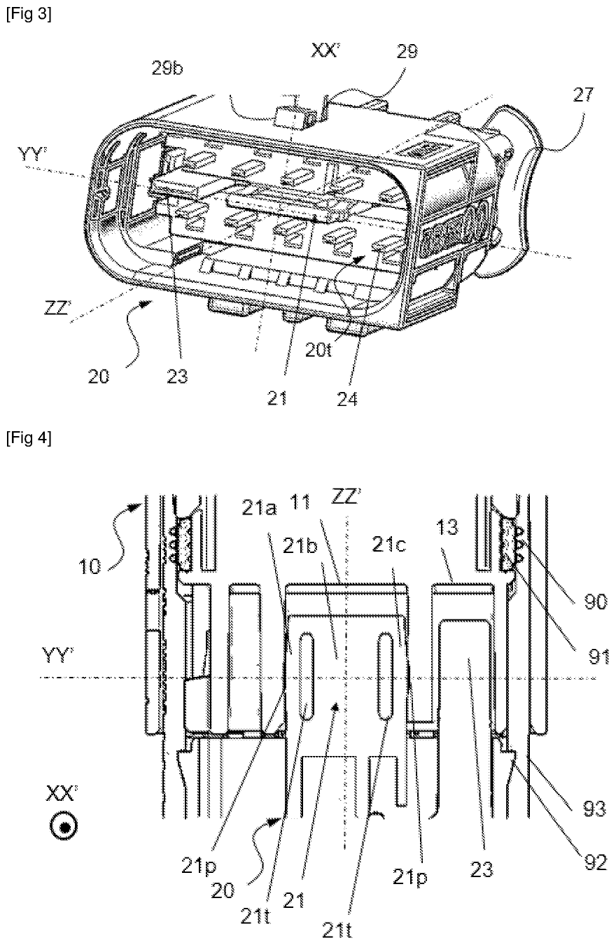

FIG. 3 represents a view in perspective of the electrical connector 20 according to the first embodiment.

The electrical connector 20 has the protrusions 29, 29b as discussed with reference to FIG. 1.

The electrical connector 20 has the coupling element 21, the other coupling element 23, and the male terminals 24 as discussed with reference to FIG. 2.

The coupling element 21 extends in the direction of introduction ZZ′. In addition, it is preferably flat, i.e., on the plane formed by the direction of introduction ZZ′ and the first direction YY′. It therefore has a thickness in a second direction XX′ perpendicular to the first direction YY′ and to the direction of introduction ZZ′.

The coupling element 21 of the electrical connector 20 is designed to be inserted in the receptacle 11 of the corresponding electrical connector 10. This makes it possible to assure coupling (or pairing) of the electrical connector 20 and the corresponding electrical connector 10.

FIG. 4 represents a first view in cross-section of the electrical connector 20 connected to the corresponding electrical connector 10. In this case, the electrical connector 20 is represented inserted in the corresponding electrical connector 10.

The coupling element 21 has two (first) protuberances 21p which are projections in the first direction YY′, preferably towards the exterior of the coupling element 21. These protuberances 21p abut the inner walls of the receptacle 11 (also known as the housing 11) and make it possible to limit the vibrations at the electrical connector 20. This makes it possible to make the connection more reliable.

The coupling element 21 can have a central portion 21b and two flexible portions 21a, 21c. The flexible portions 21a, 21c are arranged laterally in the first direction YY′ and are separated from the central portion 21b by openings such as slots 21t. The protuberances 21p are preferably on-board the flexible portions 21a, 21c.

The corresponding electrical connector 10 can also have a lip seal 91, with one or more lips 90. When the corresponding electrical connector 10 is connected to the electrical connector 20, the lip seal 91 will be deformed and be compressed, in particular at the lips 90, such as to stop or limit the intake of water, pollutants, and/or dust from the exterior.

In addition, the electrical connector 20 can have flexible arms 92 arranged at the male terminal supporting the male terminals 24, such as to be able to block the terminal in an outer wall having housings 93. The outer wall of the electrical connector 20 is designed to receive the terminal 20t supporting the male terminals 24, and the housings 93 are designed to receive the flexible arms 92.

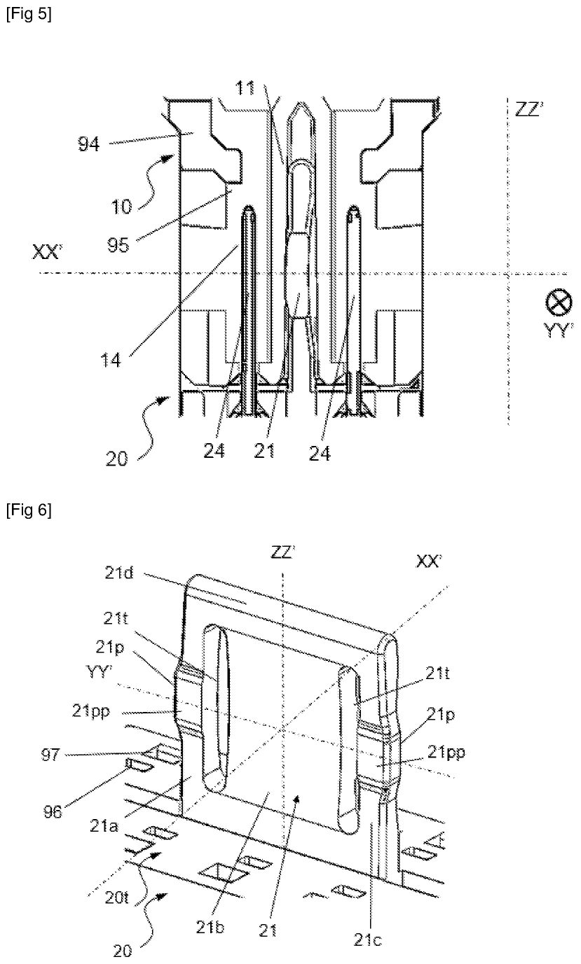

FIG. 5 represents a second view in cross-section of the electrical connector 20 connected to the corresponding electrical connector 10. Due to the protuberances, the coupling element 21 is firmly retained in the receptacle 11, which makes it possible to make the connection reliable, in particular the electrical connection at the male terminals 24.

The corresponding electrical connector 10 can also have a cavity 95 which cooperates with a secondary lock 94. The secondary lock 94 is designed to assure the positioning of the female terminal. At its female terminals 14, the female terminal is designed to receive the male terminals 24 of the male terminal of the electrical connector 20, as described hereinafter with reference to FIG. 10.

FIG. 6 represents a detailed view of the electrical connector 20 according to the first embodiment, seen from a first side.

As previously indicated, the coupling element 21 has the central portion 21b and the flexible portions 21a, 21c separated by slots 21t.

The coupling element 21 also has two (second) protuberances 21pp which are projections in the second direction XX′, preferably towards the exterior of the coupling element 21. These protuberances abut the inner walls of the receptacle 11 (also named the housing 11) and make it possible to limit the vibrations at the electrical connector 20. This makes it possible to make the connection more reliable. It is also possible to provide a base 12 of the receptacle 11 with a reduced dimension (i.e., smaller than the dimensions of the coupling element 21 at the protuberances), such as to increase the interference between the protuberances 21p, 21pp and the receptacle. In other words, the base 12 (or closed end 12 of the receptacle 11 opposite the open end via which the coupling element 21 can be introduced) can have a rounded or chamfered form such as to create or reinforce the interference or area of contact with the protuberances 21p, 21pp or with another portion of the coupling element, such as, for example, the end 21d of the coupling element or the sides of the coupling element 21.

The coupling element 21 also preferably has a rounded end 21d in order to facilitate the introduction of the coupling element 21 into the receptacle 11.

The fact that the protuberances are arranged in the first direction YY′ and the second direction XX′, on flexible portions, improves further the resistance to vibrations.

The male terminal of the electrical connector 20 can also have terminal openings 96 which are designed to receive the male terminals 24, and terminal dismantling openings 97, which are designed to receive a tool such as a screwdriver or a dismantling tool, in order to dismantle the male terminals 24, as illustrated in greater detail with reference to FIG. 12.

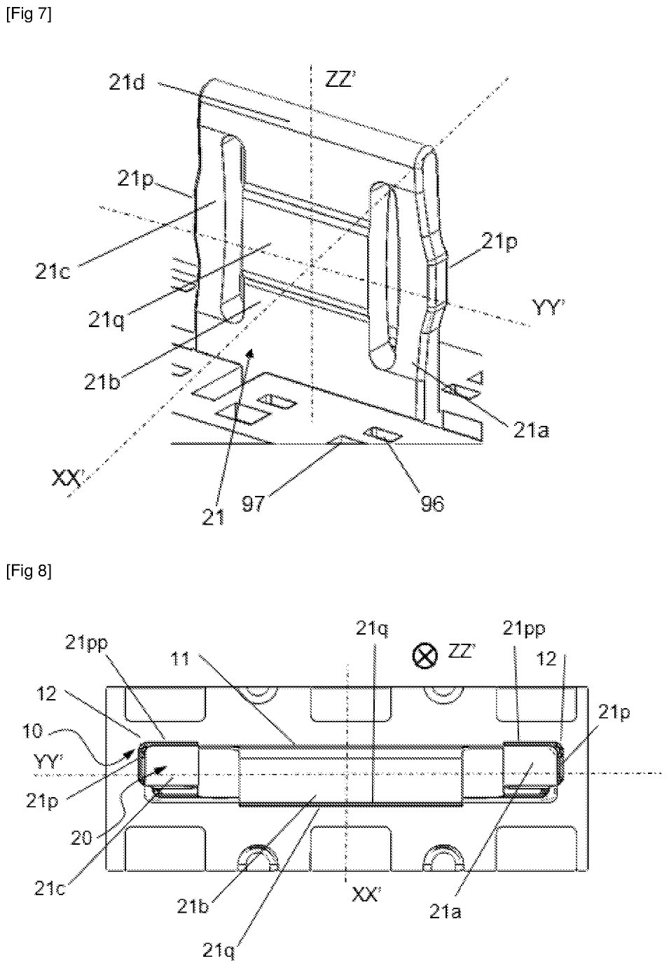

FIG. 7 represents a detailed view of the electrical connector 20 according to the first embodiment, seen from the second side, opposite the first side in FIG. 6.

In this case, the coupling element 21 has a third protuberance 21q arranged at the central portion 21b. This makes it possible to improve further the resistance to vibrations. The central portion 21b can also be flexible (for example depending on its form).

The third protuberance 21q is a projection in the second direction XX′, i.e., it projects in the second direction XX′. It should be noted that the protuberances 21p project in the first direction YY′, and the protuberances 21pp project in the second direction XX′.

FIG. 8 represents a third view in cross-section of the electrical connector 20 connected to the corresponding electrical connector 10.

The electrical connector 20 is represented inserted in the corresponding electrical connector 10. The protuberances are thus in contact with the respective inner walls of the receptacle 11, such as to improve the resistance to vibrations (for example by limiting their amplitude). Thus, the flexible portions 21a, 21c are compressed when they are introduced into the receptacle 11, therefore improving the resistance to vibrations (in particular in the first direction YY′ and the second direction XX′, but also in the direction of introduction ZZ′). The central portion 21b can also be designed to be flexible and can thus also be compressed for the same purposes. It is also advantageous to provide the protuberances 21pp on a side of the coupling element and the protuberance 21q on the opposite side, in order to improve further the resistance to vibrations and to tension the coupling element 21.

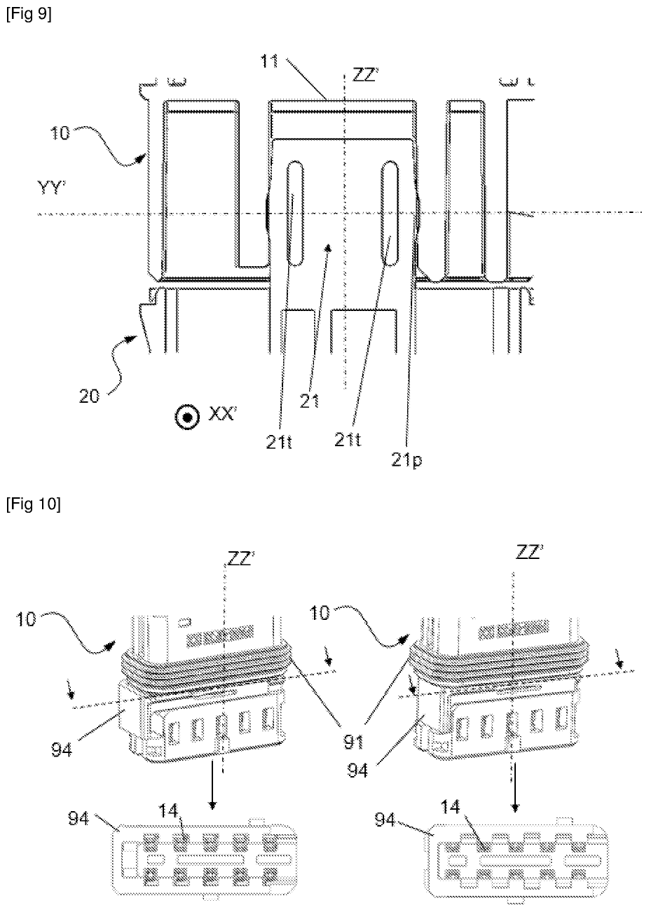

FIG. 9 represents a fourth view in cross-section of the electrical connector 20 connected to the corresponding electrical connector 10.

Elements which are common to the different figures are repeated as many times as necessary.

FIG. 10 represents a view in perspective of the corresponding connector 10, with views in cross-section having the secondary lock 94. When the secondary lock 94 is pre-positioned (as illustrated in the left-hand part of FIG. 10), it is possible to insert the female terminals 14 in the female terminal of the corresponding electrical connector 10. When the secondary lock 94 is displaced into the blocking position (as illustrated in the right-hand part of FIG. 10), the female terminals 14 are blocked in nominal position, and can thus receive the male terminals 24, in normal operation. If the female terminals 14 are not well-positioned during the fitting, it is not possible to close the secondary lock 94. Thus, the secondary lock 94 makes it possible to assure good positioning of the female terminals 14 in the corresponding electrical connector 10. FIG. 10 also shows a view in cross-section of each of the positions of the secondary lock 94 (in the pre-positioned position on the left, in the blocking position on the right).

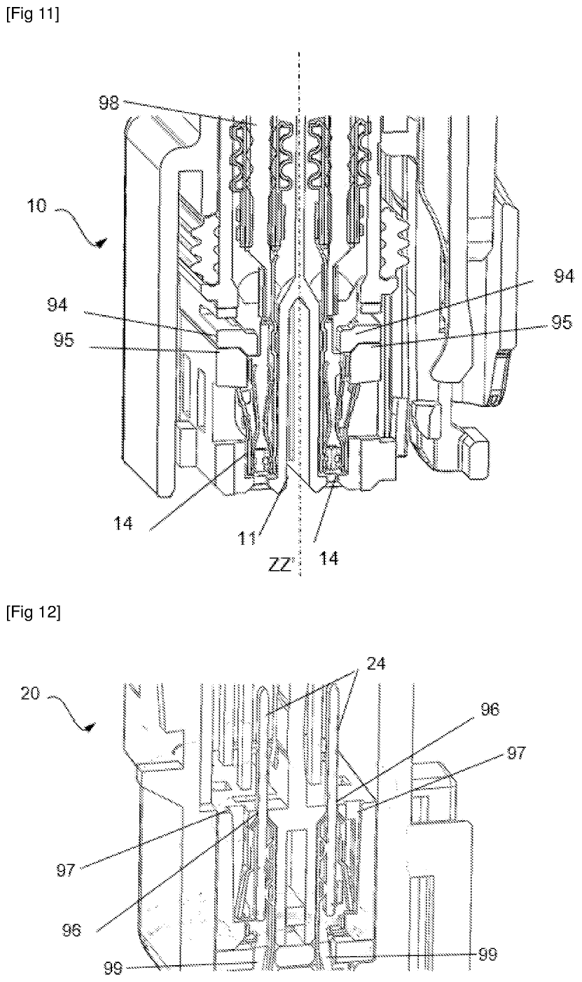

FIG. 11 represents a view in cross-section of the corresponding electrical connector 10.

The elements which are common to the different figures are repeated as many times as is necessary.

The corresponding electrical connector 10 is illustrated with the secondary lock 94 and the female electric terminals 14. The male electric terminals 24 can thus be inserted from the bottom of FIG. 11, in the direction ZZ′. The female terminals 14 can be connected to electric cables 98.

FIG. 12 represents a view in cross-section of the electrical connector 20.

As previously indicated, the electrical connector 20 can also have terminal openings 96 which are designed to receive the male terminals 24, and terminal dismantling openings 97 which are designed to receive a tool such as a screwdriver or a dismantling tool, in order to dismantle the male terminals 24. The male terminals 24 can be connected to electric cables 99 (in a manner similar to the female terminals 14 with the electric cables 98).

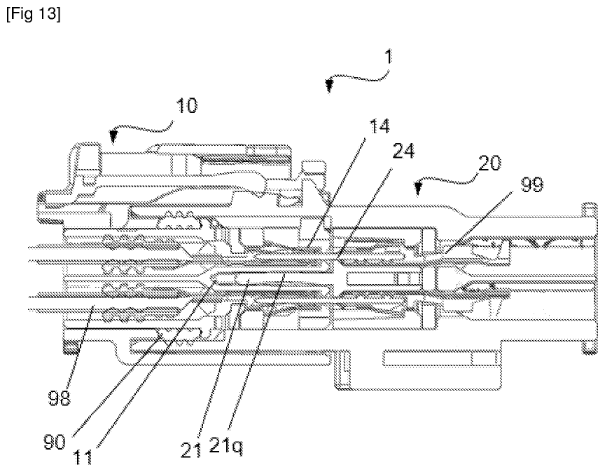

FIG. 13 represents a view in cross-section of the electrical connector 20 and the corresponding electrical connector 10 connected together.

The electrical connector 20 is represented connected and coupled to the corresponding electrical connector 10, as previously described.

It is possible to combine the embodiments and/or the variants as much as is possible or necessary.

The coupling element 21 is preferably made of plastic or any appropriate material.

It will be understood that various modifications and/or improvements which are apparent to persons skilled in the art can be made to the different embodiments described in the present description. In particular, reference is made to the possibility of displacing the protuberances in the direction ZZ′ for example (i.e., at the level of a first third of the coupling element, at the level of halfway along the coupling element, or at the level of a second third of the coupling element, or upstream or downstream from these values), or of modifying the form or size of the openings 21t. It is also possible to provide the protuberances 21q and 21pp on the same face of the coupling element 21, or to provide the two protuberances 21pp on opposite faces, and/or to provide two protuberances 21q on the central portion 21b. It is also possible to invert the coupling element and the corresponding housing in the electrical connector and the corresponding electrical connector, and/or to provide the corresponding housing with the protuberances.

In some aspects, the techniques described herein relate to an electrical connector configured to be connected and coupled in a direction of introduction to a corresponding electrical connector, the electrical connector having a coupling element extending at least in the direction of introduction, wherein the coupling element includes: a first protuberance extending in a first direction perpendicular to the direction of introduction and a second protuberance extending in a second direction oriented perpendicularly to the first direction and to the direction of introduction.

In some aspects, the techniques described herein relate to an electrical connector, wherein the electrical connector is a male connector which is designed to be connected and coupled to the corresponding electrical connector, which is a female connector.

In some aspects, the techniques described herein relate to an electrical connector, wherein the coupling element has a flexible portion, the flexible portion having the first protuberance and the second protuberance.

In some aspects, the techniques described herein relate to an electrical connector, wherein the coupling element includes a central portion and two flexible portions each having the first protuberance and the second protuberance.

In some aspects, the techniques described herein relate to an electrical connector, wherein the central portion is separated from the two flexible portions by two slots.

In some aspects, the techniques described herein relate to an electrical connector, wherein the central portion has a third protuberance.

In some aspects, the techniques described herein relate to an electrical connector, wherein the coupling element is substantially flat.

In some aspects, the techniques described herein relate to an electrical connector, wherein the first protuberance projects towards an exterior of the coupling element.

In some aspects, the techniques described herein relate to an electrical connector, wherein the second protuberance projects towards an exterior of the coupling element.

In some aspects, the techniques described herein relate to an electrical connector, wherein the coupling element projects in the direction of introduction.

In some aspects, the techniques described herein relate to an electrical connector, wherein the first protuberance and the second protuberance are designed to interfere with a base of the corresponding electrical connector.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector configured to be connected and coupled in a direction of introduction to a corresponding electrical connector, the electrical connector having a coupling element extending at least in the direction of introduction, wherein the coupling element comprises:
a first protuberance extending in a first direction perpendicular to the direction of introduction; and
a second protuberance extending in a second direction oriented perpendicularly to the first direction and to the direction of introduction.

2. The electrical connector according to claim 1, wherein the electrical connector is a male connector which is designed to be connected and coupled to the corresponding electrical connector, which is a female connector.

3. The electrical connector according to claim 1, wherein the coupling element has a flexible portion, the flexible portion having the first protuberance and the second protuberance.

4. The electrical connector according to claim 3, wherein the coupling element comprises a central portion and two flexible portions each having the first protuberance and the second protuberance.

5. The electrical connector according to claim 4, wherein the central portion is separated from the two flexible portions by two slots.

6. The electrical connector according to claim 4, wherein the central portion has a third protuberance.

7. The electrical connector according to claim 1, wherein the coupling element is substantially flat.

8. The electrical connector according to claim 1, wherein the first protuberance projects towards an exterior of the coupling element.

9. The electrical connector according to claim 1, wherein the second protuberance projects towards an exterior of the coupling element.

10. The electrical connector according to claim 1, wherein the coupling element projects in the direction of introduction.

11. The electrical connector according to claim 1, wherein the first protuberance and the second protuberance are designed to interfere with a base of the corresponding electrical connector.
